(19) United States
(12) Patent Application Publication
(10) Pub. No.: US 2006/0047747 A1
(43) Pub. Date: Mar. 2, 2006

(54) System and method for automatic selection of an instant messenger client

(75) Inventors: Paul R. Erickson, Sammamish, WA (US); Kevin R. Moore, Seattle, WA (US); Cornelis K. Van Dok, Bellevue, WA (US); Deana R. Fuller, Seattle, WA (US); Peyman Oreizy, Kirkland, WA (US); Sean O. Blagsvedt, Seattle, WA (US); Walter R. Smith, Seattle, WA (US); Daniel William Crevier, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 10/875,693

(22) Filed: Jun. 24, 2004

(51) Int. Cl. G06F 15/16

(52) U.S. Cl. 709/204

(57) ABSTRACT

Automatic selection of an instant messenger (IM) client is made in response to a request to initiate a communication activity with a selected contact, such as an IM chat session. The IM client is selected according to which IM client is providing presence information related to the contact. The IM client is also selected according to which IM client is capable of handling the requested communication activity. An IM client may be selected if it can handle the requested communication activity irrespective of whether the contact is online with the IM client.

### BACKGROUND OF THE INVENTION

An Instant Messenger (IM) program provides a method for a user to send instant messages to other IM users on the Internet or on a network. IM is a type of communications service that enables a user to create a kind of private chat room with another individual in order to communicate in real time over the Internet. IM is analogous to a telephone conversation, but uses text-based, not voice-based, communication. Typically, the instant messaging system alerts a user whenever somebody on the user's private list is online. The user may then initiate a chat session with that particular individual.

With the instant messaging program, a user may perform any number of functions that include viewing the user's contacts who are online, sending an instant message, calling a contact's computer, sending a contact a file, having an instant message conversation with a group of friends, inviting someone to play a game, being notified of new e-mail messages from an e-mail account, and other activities. However, in order to receive the presence information provided by the IM program of who is online, generally a user has the IM application currently running and the IM application being viewed by the user. Other programs have been generated to provide the presence information in alternate interfaces outside of the context of the IM application. However, the usefulness of such information is limited without allowing a user to take advantage of the various activities provided by the IM application through these alternate interfaces.

### SUMMARY OF THE INVENTION

The present invention provides a system and method for automatically selecting an instant messenger (IM) client when a user requests to initiate a communication activity with a selected contact. In accordance with one aspect of the present invention, the IM client that set the contact's presence as being “Online” is launched. According to another aspect of the present invention, an IM client that allows the type of communication activity requested is launched. In one aspect, the IM client that allows the requested communication activity may allow the requested communication activity irrespective of the online status of the contact. The available IM clients are provided in an ordered list that is cycled through to determine which of the IM clients is providing the presence information. With respect to another aspect of the present invention, a default IM client may be launched. This present invention provides a solution to the problem of automatic selection of the preferred IM client caused by the requirement that IM clients start a selected communication activity with a very limited number of people who's names or addresses might appear throughout the IM client's user interface.

### BRIEF DESCRIPTION OF THE DRAWINGS

FIG. 1 illustrates an exemplary computing device that may be used in one exemplary embodiment of the present invention.

FIG. 2 illustrates an exemplary mobile device that may be used in one exemplary embodiment of the present invention.

FIG. 3 illustrates exemplary user interface outputs for an inbox and a today screen that include instant message presence information in accordance with the present invention.

FIG. 4 illustrates an exemplary sidebar that includes a sidebar tile for showing presence information in accordance with the present invention.

FIG. 5 illustrates an exemplary block diagram for a system that provides communication between other applications and IM applications in accordance with the present invention.

FIG. 6 illustrates a logical flow diagram of a process for selecting among a list of IM clients to initiate a communication activity in accordance with the present invention.

### DETAILED DESCRIPTION

The present invention now will be described more fully hereinafter with reference to the accompanying drawings, which form a part hereof, and which show, by way of illustration, specific exemplary embodiments for practicing the invention. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Illustrative Operating Environment

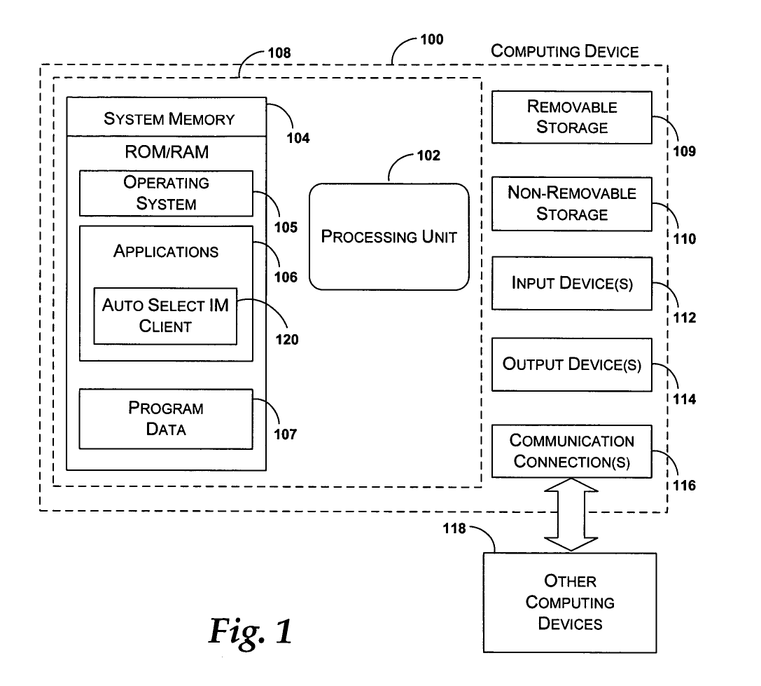

With reference to FIG. 1, one exemplary system for implementing the invention includes a computing device, such as computing device 100. Computing device 100 may be configured as a client, a server, mobile device, or any other computing device that provides client provisioning according to Open Mobile Alliance (OMA) guidelines. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. In one embodiment, application 106 includes an auto select IM client application 120 for implementing the functionality of the present invention. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

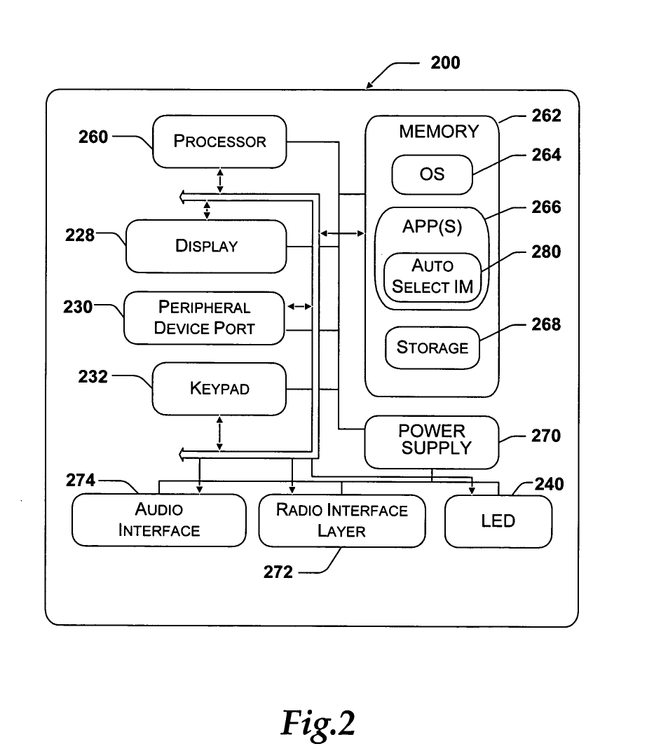

FIG. 2 shows an alternative operating environment for a mobile device substantially for use in the present invention. In one embodiment of the present invention, mobile device 200 is integrated as a computing device, such as an integrated personal digital assistant (PDA) and wireless phone.

In this embodiment, mobile device 200 has a processor 260, a memory 262, a display 228, and a keypad 232. Memory 262 generally includes both volatile memory (e.g., RAM) and non-volatile memory (e.g., ROM, Flash Memory, or the like). Mobile device 200 includes an operating system 264, which is resident in memory 262 and executes on processor 260. Keypad 232 may be a push button numeric dialing pad (such as on a typical telephone), a multi-key keyboard (such as a conventional keyboard), or may not be included in the mobile device in deference to a touch screen or stylus. Display 228 may be a liquid crystal display, or any other type of display commonly used in mobile computing devices. Display 228 may be touch-sensitive, and would then also act as an input device.

One or more application programs 266 are loaded into memory 262 and run on operating system 264. Examples of application programs include phone dialer programs, e-mail programs, scheduling programs, PIM (personal information management) programs, word processing programs, spreadsheet programs, Internet browser programs, and so forth. In one embodiment, application programs 266 include an auto select IM application 280 for implementing the functionality of the present invention. Mobile device 200 also includes non-volatile storage 268 within the memory 262. Non-volatile storage 268 may be used to store persistent information which should not be lost if mobile device 200 is powered down. The applications 266 may use and store information in storage 268, such as e-mail or other messages used by an e-mail application, contact information used by a PIM, appointment information used by a scheduling program, documents used by a word processing application, and the like. A synchronization application also resides on the mobile device and is programmed to interact with a corresponding synchronization application resident on a host computer to keep the information stored in the storage 268 synchronized with corresponding information stored at the host computer.

Mobile device 200 has a power supply 270, which may be implemented as one or more batteries. Power supply 270 might further include an external power source, such as an AC adapter or a powered docking cradle that supplements or recharges the batteries.

Mobile device 200 is also shown with two types of external notification mechanisms: an LED 240 and an audio interface 274. These devices may be directly coupled to power supply 270 so that when activated, they remain on for a duration dictated by the notification mechanism even though processor 260 and other components might shut down to conserve battery power. LED 240 may be programmed to remain on indefinitely until the user takes action to indicate the powered-on status of the device. Audio interface 274 is used to provide audible signals to and receive audible signals from the user. For example, audio interface 274 may be coupled to a speaker for providing audible output and to a microphone for receiving audible input, such as to facilitate a telephone conversation.

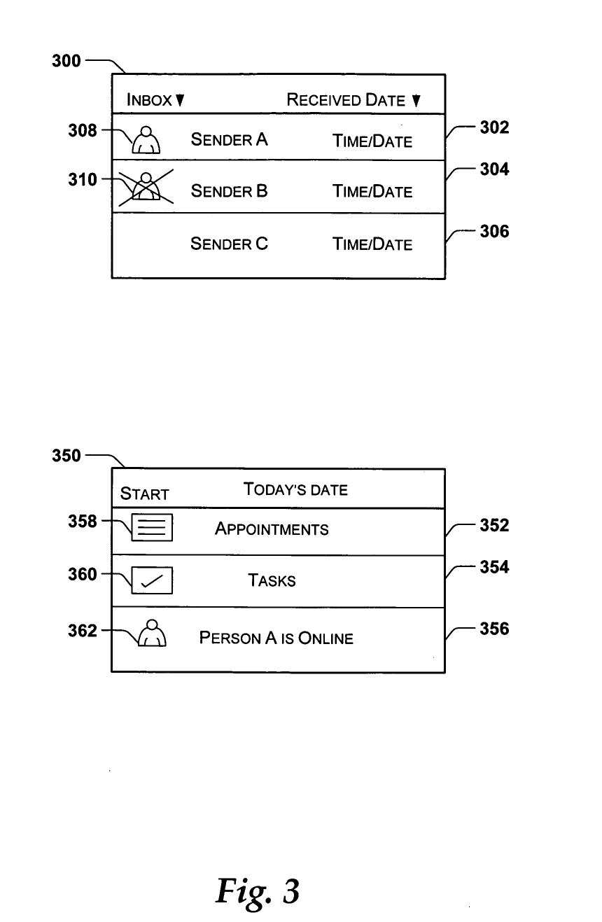

Mobile device 200 also includes a radio 272 that performs the function of transmitting and receiving radio frequency communications. Radio 272 facilitates wireless connectivity between the mobile device 200 and wide area network 340 (FIG. 3), via a communications carrier or service provider. Transmissions to and from the radio 272 are conducted under control of the operating system 264. In other words, communications received by the radio 272 may be disseminated to application programs 266 via the operating system 264, and vice versa.

The radio 272 allows the mobile device 200 to communicate with other computing devices, such as over a network. The radio 272 is one example of communication media.

Automatic IM Client Selection

One of the primary functions of an operating system is to appropriately launch other applications; an operating system establishes user interface metaphors and creates application program interfaces (APIs) so that users can launch expected applications at expected times. For example, when a user clicks on the document editor icon in the programs menu, the document editor is launched rather than another program. As the operating system matured, a limited set of “canonical” actions were created such as “mailto” that launched a user's default mail client application. These canonical actions allowed user to apply a verb to an object enabling functionality such as the ability with the “mailto” action whereby a user can click on any email address—in any application—and the user's preferred email application is launched with the address pre-configured. Previously, users needed to first open a given email application and then enter the email address.

Like the “mailto” verb, one embodiment of the present invention generates default verbs for starting IM communication activities. Unlike mail applications, most IM clients today do not let users communicate with any other person with an email address. Most only enable communication with other people that are part the IM client's “buddy list” and also use the same IM client. Thus, many users maintain and use multiple IM clients so that they can communicate with other people who have varying IM clients. This makes the problem of automatic selection of the preferred IM client rather difficult because unlike email applications, where any client can send mail to any person with any sort of mail address, IM clients can usually only successfully start a selected communication activity with a very limited number of people who's names or addresses might appear throughout the user interface. To help address this problem, the invention proposes a system to enable automatic selection of an IM client based on the presence value of the contact with whom the user wishes to communicate. In brief, whichever IM client, within an ordered list of providers, sets the contact's presence as being “Online”, is the IM client that is launched. In ambiguous cases, a default IM client may be launched.

As used herein throughout the specification and the claims, IM client application, IM client, IM provider, and provider are used interchangeably as corresponding to the applications and services that provide the instant messaging service and functionality to the user.

FIG. 3 illustrates exemplary user interface outputs for an inbox and a today screen that include IM presence information in accordance with the present invention. Inbox 300 includes entries 302, 304, and 306. Each entry shows the sender of the e-mail to the user (e.g., sender A, sender B, sender C) and the time and date of the e-mail delivery. As is known with inbox applications such inbox 300 shown, other fields may also be included (e.g., subject, etc.) that provided further information regarding the mail sent or received.

In accordance with the present invention, each entry (e.g., 302) may also include an icon (e.g., 308, 310) that provides an indication of a relationship between the sender and the recipient as well as the IM presence for the sender of the e-mail. For example, sender A has an associated icon 302. First, icon 302 signifies that sender A is a “buddy” of the user. Stated differently, sender A is included in a list of individuals or groups to which the user sends or receives IM messages, also called a “buddy list.”

Secondly, icon 302 signifies that sender A is “online”. “Online” refers to sender A being currently able to hold an IM session with the user. In contrast, icon 304 shows that sender B is a buddy of the user, but the “X” through icon 304 indicates that sender B is not online. Furthermore, sender C, by not having an associated icon, is neither online nor included within the buddy list of the user.

Today screen 350 is similar to inbox 300 while providing the user with information other than received or sent e-mails. Today screen 350 includes different portions of an application that a user may access to perform various operations. For example, appointment entry 352 may be selected to view a user's appointments, or tasks entry 354 may be selected to view a user's tasks. In the example shown, each entry has an associated icon (e.g., 358 and 360), but in other embodiments may have different or additional information associated with each entry.

In accordance with the present invention, today screen 350 also includes an entry, or entries that provide IM presence information. For example, entry 356 is included that notifies the user that “person A is online”. Again, entry 356 has an associated icon 362, but in other embodiments may include different icons or none.

With either inbox 300 or today screen 350, the icons shown are exemplary only, and other icons or indicators of whether a contact is a member of a buddy list or online may be used. In one embodiment, a user may initiate an IM session with a person or group indicated as being online by selecting the associated icon or the entry. The present invention provides for selecting an IM client to launch for commencing the IM session as described below.

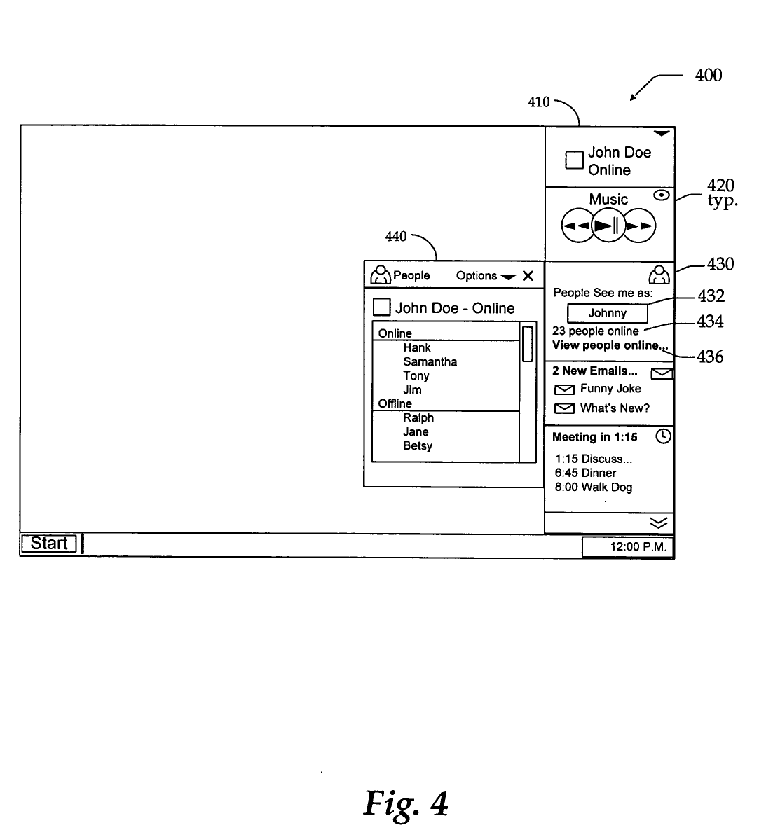

FIG. 4 illustrates an exemplary sidebar within a desktop in accordance with the present invention. Sidebar 410 in desktop 400 includes tiles (e.g., 420) that provide a variety of information to the user during a computing session. For example, tiles within sidebar 410 may include media information, e-mail notifications, schedule notifications, as well as other information. Each tile may include icons and other content that differentiates the tiles from one another. Also included in accordance with the present invention is presence information sidebar tile 430, that provides presence information to the user.

The exemplary presence information sidebar tile 430 includes an indicator of presence published by the user 432, notification of presence of other users 434, and selection to view more detailed presence information 436. In this example, indicator 432 provides the alias selected by the user that is published to other users on the network. Notification 434 provides a dynamically updated number of the users that are currently considered online (e.g., 23 users are online). Selection 436 provides a link to more detailed information regarding the presence of other users on the network. For example, when a user selects selection 436, window 440 is opened to provide the user with the detailed information.

Window 440 provides the user with more detailed information of IM users on the network. In one embodiment, the information within window 440 includes presence information along with contact information provided by a contacts application associated with the computing device. For example, detailed information in window 440 may include a differentiation of those contacts that are offline and those that are online in a different format than shown in FIG. 3. Other details of the users and contacts present on the network may also be provided through window 440. In one embodiment, window 440 is a “flyout” or window that is a component of the sidebar tile. In another embodiment, window 440 is produced by a contacts application and the presence information is provided to the contacts application for inclusion within the contacts user interface.

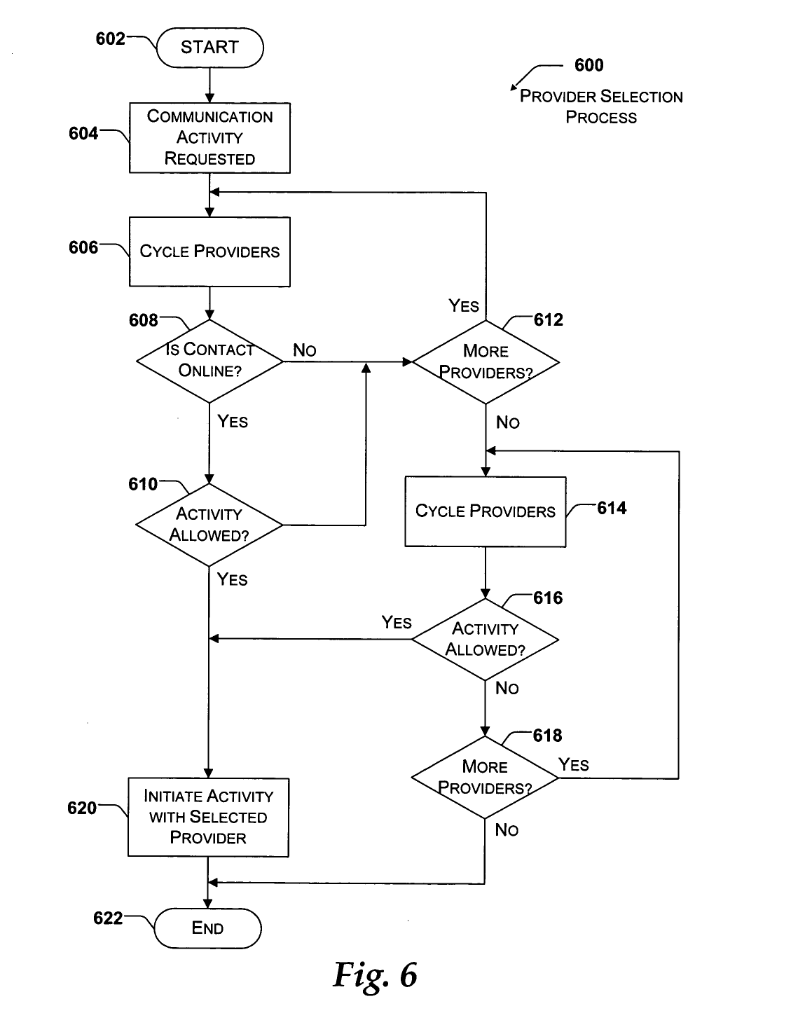

While FIG. 4 shows that the presence of each contact on the network is shown within the flyout of the sidebar tile, in other embodiments, the format of sidebar tile 430 may be different. The sidebar tile itself may show the contacts of the IM applications that are online without using a flyout to present the presence information. Accordingly, the sidebar tile itself includes a dynamically updated list of contacts for which presence information is displayed. As described further in the discussion of FIG. 6 below, a user may select any one of the contacts with which to initiate a communication activity. The present invention then selects the appropriate IM client to launch in order to commence the communication activity.

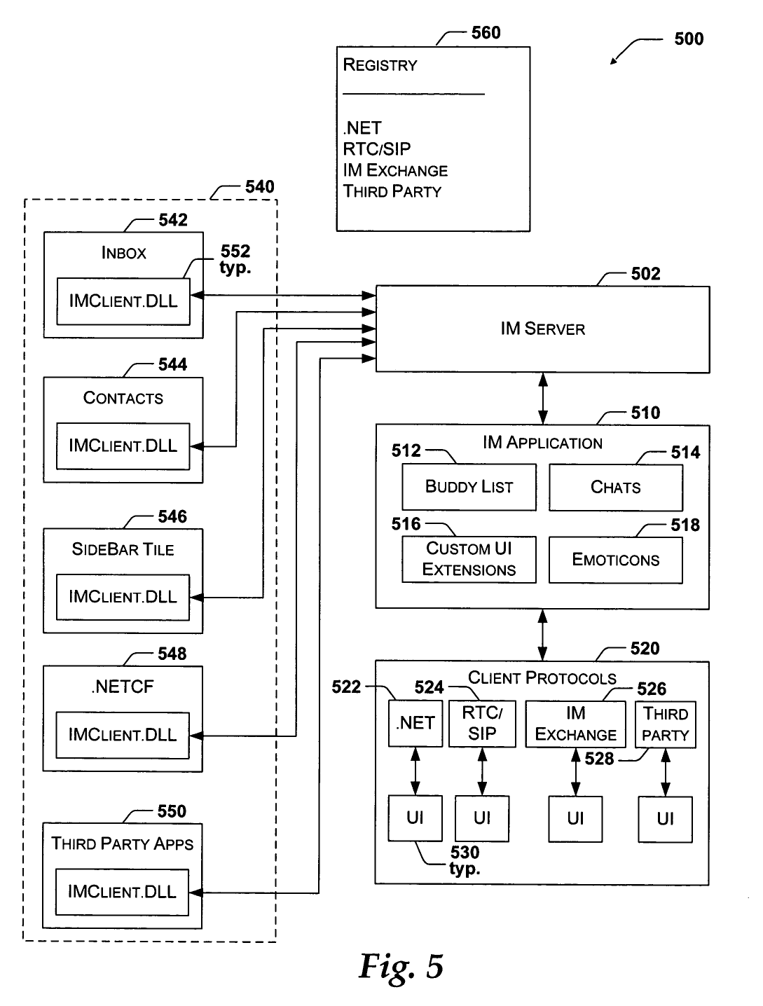

FIG. 5 illustrates an exemplary block diagram for a system that provides communication between other applications and IM applications in accordance with the present invention. System 500 includes IM server 502, IM application 510, client protocols 520, presence display applications 540 and registry 560. IM application 510 includes buddy list 512, chats 514, custom UI extensions 516, and emoticons 518. Protocols 520 include one or more of the protocols NET Messenger Service 522, RTC/SIP 524, IM exchange 526, and possibly third party protocols 528. Each client protocol has an associated user interface (UI) 530. Presence display applications 540 include inbox 542, contacts 544, sidebar tile 546, and third party applications written with the NET Compact Framework 548 or native code 550. Each presence display application also includes an IMclient.dll, or IM client dynamic link library 552.

In one embodiment, each presence display application (e.g., 546) is populated with instructions for providing IM presence information and interacting with the IM clients using IMclient.dll 552. The IM presence information is provided to each presence display application (e.g., 542) through IM server 502. IM application 510 uses protocol information according the protocol of the particular user's IM application to present the IM presence information in the other applications such as sidebar tile 546. Additionally, IM server 502 receives IM client launch requests from the presence display applications (e.g., 546) when a user selects a contact listed within a particular presence display application with which the user desires to interact (e.g., initiate an IM session).

In one embodiment, IM application 510 is indicative of any one of the possible IM clients available for providing presence information and activities corresponding to a particular contact. The various IM clients are shown by the variety of client protocols available for providing an IM service to a user.

In another embodiment, IM application 510 is provided as an application programming interface (API) that combines portions of the IM client applications (e.g., combining the buddy lists into single buddy list 512) to provide consistency in the presence information displayed.

In an embodiment of the present invention, the above architecture is used in deciding which of third party IM client applications or IM client protocols to use when a user has selected to initiate an IM session. For example, the user may have decided to initiate a chat session with a particular contact. The present invention provides the algorithm for choosing the appropriate IM client to launch (or the appropriate structure of the IM application API) for the chat session. In one embodiment, the IM clients are searched for the appropriate IM client in the order that the IM clients are listed in registry 560. In another embodiment, the user is allowed to select the order of the IM clients listed in registry 560. The process for choosing the appropriate IM client to launch is described in the discussion of FIG. 6 below.

FIG. 6 illustrates a logical flow diagram of a process for selecting among a list of IM providers (i.e., IM client applications) to initiate a communication activity in accordance with the present invention. Process 600 starts at block 602 where the requisite code is present on a computing device for providing presence information and launching an IM client application. Processing continues at block 604.

At block 604, the system monitors for when a communication activity is requested corresponding to a particular contact. In one embodiment, code resident on the application providing the presence information is aware when a user selects to initiate a communication activity (e.g., chat session) with a particular contact. The resident code (e.g., IMCLient.DLL of FIG. 5) then forwards this request to the IM server. In another embodiment, the resident code may communicate the request directly with the IM client application to have the provider initiate the communication activity. Processing continues at block 606.

At block 606, an ordered list of providers (e.g., registry 560 in FIG. 5) is cycled through for determinations of whether a particular contact is online with that provider and whether the provider includes functionality for initiating the communication activity. The cycle begins with the first provider in the ordered list, and continues down the list incrementally if block 606 is reached again during the execution of process 600. The number of providers in the list is not limited to a specified number of IM client applications. Furthermore, the list of providers is not limited to services that only provide instant messaging service. Other providers may be included that support other communication protocols that may be initiated with relation to a particular contact without departing from the spirit and scope of the invention. While the providers are cycled, processing continues at decision block 608.

At decision block 608, a determination is made whether the contact is online with the current provider of the ordered list. The determination of the contact being online with the current provider may be discovered by examining whether the current provider is the IM client application that is providing the presence information for the contact. If the contact is online with the current provider, processing advances to decision block 610. However, if the contact is not online with the current provider, processing moves to decision block 612.

At decision block 610, a determination is made whether the current provider allows the communication activity corresponding to the communication activity requested. For example, a video streaming of data may be allowed by certain providers but not by others. The current provider may be providing the presence information related to the contact, but may not allow video streaming of data to that contact. If the activity is not allowed, processing moves to decision block 612. However, if the activity is allowed processing moves to block 620 where the activity is initiated.

At decision block 612, a determination is made whether other providers are available within the ordered list of providers that have not yet been cycled in process step 606. Other providers may also be providing the presence information for the particular contact (e.g., more than one provider may be supplying presence information to the particular contact). If more providers are available that have not been cycled in process step 606, processing returns to block 606 where those providers are cycled. However, if more providers are not available (e.g., all providers in the ordered list have been cycled to determine if a contact is online), processing moves to block 614.

At block 614, cycling of the providers is reinitiated, so that the ordered list of providers is cycled through again. The cycle begins with the first provider in the ordered list, and continues down the list incrementally if block 614 is reached again during the execution of process 600. Once the cycling of the providers is reinitiated, processing continues at decision block 616.

At decision block 616, similar to block 610, a determination is made whether the current provider allows the communication activity corresponding to the communication activity requested. Certain activities may be performed with relation to a particular contact with requiring that the contact be online. Accordingly, the providers are cycled through to determine if the current provider allows the communication activity requested without the contact having an online presence. If the current provider does allow the requested communication activity, processing advances to block 620, where the requested communication activity is initiated. However, if the current provider does not allow the requested communication activity, processing continues at decision block 618.

At decision block 618, similar to decision block 612, a determination is made whether other providers are available within the ordered list of providers that have not yet been cycled in process 600. Other providers may allow the requested communication activity while the contact is offline if the current provider does not. If more providers are available that have not been cycled in process step 614, processing returns to block 614 where those providers are cycled. However, if more providers are not available (e.g., all providers in the ordered list have been cycled to determine if a provider allows the requested communication activity), processing moves to block 622 where the communication activity request fails and process 600 ends.

At block 620, as previously stated, the requested communication activity is initiated. For example, if the activity is a chat session, the user interface corresponding to the current provider is launched to commence the chat session. Other activities may be used than those described herein. Once the requested communication activity is initiated, processing advances to block 622 where process 600 ends.

In one embodiment, the decision for which of the providers to use in initiating the requested communication activity may be made solely on whether the provider is providing the presence information related to the selected contact. In another embodiment, the decision for which of the providers to use in initiating the requested communication activity may be made solely on whether the provider is capable of supporting the requested communication activity (i.e., whether the providers allows the activity). In still a further embodiment, the order of the queries may be reversed, where the query is first made whether the provider is capable of supporting the requested communication activity, and then the query is made whether the provider is providing the presence information related to the selected contact.

In yet another embodiment, a default provider may be selected for initiating the requested communication activity. For example, instead of failing the communication activity request when none of the available providers is providing the presence information or is capable of supporting the requested communication activity, a default provider is selected to initiate the communication activity by whatever means it has available. In still a further embodiment, a preferred provider may be designated. With the preferred provider, the preferred provider is used for all communication activities unless the preferred provider is incapable of launching a requested communication activity. If the preferred provider is incapable of launching the requested communication activity, then process 600 is commenced to determine another provider to launch the requested communication activity.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for launching a communication activity with a contact, comprising:
receiving a request to initiate a communication activity;
querying an ordered list of providers for first provider that has presence information associated with the contact; and
launching the communication activity according to the first provider that has presence information associated with the contact.

2. The computer-implemented method of claim 1, further comprising querying the first provider that has presence information for whether the first provider is capable to launch the communication activity.

3. The computer-implemented method of claim 2, further comprising launching the communication activity when the first provider that has presence information associated with the contact also indicates a capability to launch the communication activity.

4. The computer-implemented method of claim 1, wherein the ordered list of providers is stored within a registry.

5. The computer-implemented method of claim 4, wherein a user selects an order of the ordered list of providers stored within the registry.

6. The computer-implemented method of claim 1, wherein launching the communication activity further comprises communicating with an application associated with the first provider that has presence information associated with the contact to launch the communication activity.

7. The computer-implemented method of claim 1, wherein launching the communication activity further comprises communicating with an application program interface associated with the providers within the list of ordered providers to launch the communication activity with the first provider that has presence information associated with the contact.

8. The computer-implemented method of claim 1, further comprising launching a default provider when none of the providers within the ordered list of providers has presence information associated with the contact.

9. The computer-implemented method of claim 1, wherein querying the ordered list of providers is commenced after a determination that a preferred provider is incapable of launching the communication activity.

10. A system for launching a communication activity with a contact, comprising:
a computing device that includes an application that is configured to:
receive a request to initiate a communication activity;
query an ordered list of providers for first provider that is capable of launching the communication activity; and
launch the communication activity according to the first provider that is capable of launching the communication activity.

11. The system of claim 10, wherein the application is further configured to query the first provider that is capable of launching the communication activity for whether the first provider has presence information associated with the contact.

12. The system of claim 11, wherein the application is further configured to launch the communication activity when the first provider that is capable of launching the communication activity also has presence information associated with the contact.

13. The system of claim 10, wherein the ordered list of providers is stored within a registry.

14. The system of claim 13, wherein a user selects an order of the ordered list of providers stored within the registry.

15. The system of claim 10, wherein the application is further configured to communicate with another application associated with the first provider to launch the communication activity.

16. The system of claim 10, wherein the application is further configured to communicate with an application program interface associated with the providers within the list of ordered providers to launch the communication activity with the first provider.

17. The system of claim 10, wherein the application is further configured to launch a default provider when none of the providers within the ordered list of providers has presence information associated with the contact.

18. The system of claim 10, wherein the application is further configured to query the ordered list of providers after a determination that a preferred provider is incapable of launching the communication activity.

19. A computer-readable medium that includes computer-executable instructions for launching a communication activity with a contact, the instructions comprising:
receiving a request to initiate a communication activity;
querying an ordered list of providers for first provider that has presence information associated with the contact;
querying the first provider that has presence information associated with the contact for the capability to launch the communication activity; and
launching the communication activity according to the first provider that has presence information associated with the contact and indicates that it is capable of launching the communication activity.

20. The computer-readable medium of claim 19, wherein the ordered list of providers is stored within a registry.

21. The computer-readable medium of claim 21, wherein a user selects an order of the ordered list of providers stored within the registry.

22. The computer-readable medium of claim 19, wherein launching the communication activity further comprises communicating with an application associated with the first provider that has presence information associated with the contact to launch the communication activity.

23. The computer-readable medium of claim 19, wherein launching the communication activity further comprises communicating with an application program interface associated with the providers within the list of ordered providers to launch the communication activity with the first provider that has presence information associated with the contact.

24. The computer-readable medium of claim 19, further comprising launching a default provider when none of the providers within the ordered list of providers has presence information associated with the contact.

25. The computer-readable medium of claim 19, wherein querying the ordered list of providers is commenced after a determination that a preferred provider is incapable of launching the communication activity.
